(19) United States
(12) Patent Application Publication
(10) Pub. No.: US 2004/0090427 A1
(43) Pub. Date: May 13, 2004

(54) Die-cut overlays for touch-sensitive screens

(75) Inventors: Philip E. Blair, Fairport, NY (US); Debora Margaret Hejza Litwiller, Rochester, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/291,904

(22) Filed: Nov. 8, 2002

(51) Int. Cl. G09G 5/00

(52) U.S. Cl. 345/173

(57) ABSTRACT

An overlay for use with a screen, wherein the screen is a touch sensitive screen with a display containing at least one touch selectable feature thereon, wherein the overlay includes a substrate for placement over the screen, wherein the substrate has at least one hole positioned over the at least one touch selectable feature.

### BACKGROUND AND SUMMARY

Office equipment, such as that illustrated in FIGS. 1 and 2 for example, often have control or configuration panels through which the user thereof operates the equipment along with display screens presenting menu options or other various selections in order to configure the equipment prior to use. The selectable menu options displayed are often presented on a display and are navigable and selectable by the control panel itself or by touch screen display with options navigable and selectable by the user physically touching the surface of the display itself to navigate and select option presented thereon. Such displays often have many levels of hierarchically structured menus because, depending on the complexity of the number and type of selectable options there may not be enough real estate or physical room on the display on which to fit all the various options available. A user of such equipment, in order to select all their desired options to setup or otherwise configure a complex machine to their particular job requirements, will most likely be required to navigate through the plurality of options available by using local controls/keypad or by repeatedly touching the screen display itself.

For instance, assume that a user of a piece of multi-function equipment as illustrated in FIG. 1 or FIG. 2 desires to have copies made using certain paper other than that is currently available in the default paper tray. Such a user would navigate over the various options available until they reached options for selecting a secondary tray of paper. This may or may not involve navigating through a hierarchy of options in order to reach the various paper tray selections. Once the user has navigated to the desired options they would enter or otherwise formalize their selection by pressing ENTER on the control panel or keypad or by physically touching that selectable option on the display screen itself. After the desired paper tray has been selected, the machine will initiate a mechanical switching of the paper trays such that the desired paper type becomes ready for use. After other options have been entered, the user will typically select START or PRINT/COPY to begin copying.

Individuals that are impaired may encounter difficulty setting up, configuring or operating such multi-function equipment. If, for example, the user is visually impaired they may not clearly see the options displayed or other helpful information. If the user is completely visually impaired, they may not be able to use such multi-function equipment without the assistance of others. If the user has limited motor skills or has difficulty with fine motor control their use of such equipment may be precluded because they may not be able to manipulate the controls or keypad buttons to navigate and select options presented or, if the machine has a touch screen display which requires an accurate physical touching on the surface of the display itself, such impaired users not be able to use such machines without assistance. This problem is highlighted in the case of those users whose physical impairment is so severe that they require the use of a mouth-stick, or puff-stick, or eye-pointer, or some other specialized augmentative communication device to communicate with the world around them. Buttons or keys on control panels are often too small or are not accessible. Touch screen displays are again particularly troublesome because these displays require an accurate physical touching of the display surface. Such displays may not be handicap accessible or the touchable areas comprising the display may be too small. Further, because touch screen displays are intended to be sensitive to the touch, if such an impaired user drags their finger or augmentative pointing device across the display surface they may inadvertently touch (select) unintended options. These kinds of difficulties also highlight the need in the arts for alternate means to make such multi-function equipment more readily accessible to impaired persons.

Embodiments include an overlay for use with a screen, wherein the screen is a touch sensitive screen with a display containing at least one touch selectable feature thereon, wherein the overlay includes a substrate for placement over the screen, wherein the substrate has at least one hole positioned over the at least one touch selectable feature.

### BRIEF DESCRIPTION OF THE DRAWINGS

The embodiments will be described in detail herein with reference to the following figures in which like reference numerals denote like elements and wherein:

FIG. 1 illustrates a graphic representation of a printing device;

FIG. 2 illustrates an exemplary embodiment of a display screen corresponding to the first device, including a first GUI;

FIG. 3 illustrates a graphic representation of a second printing device;

FIG. 4 illustrates an exemplary embodiment of a second display screen corresponding to the second device, including a second GUI;

FIG. 5 illustrates the exemplary display of FIG. 4 with a grid superimposed on top;

FIG. 6 illustrates an exemplary embodiment of a frame having raised areas;

FIG. 7 illustrates an exemplary embodiment of a monitor display with tactilely distinguishable elements about its periphery;

FIG. 8 illustrates an exemplary embodiment of an overlay for a screen having raised portions;

FIG. 9 illustrates a view of an exemplary embodiment of an overlay with raised portions and the frame;

FIG. 10 illustrates another view of an exemplary embodiment of an overlay for a screen having raised portions in conjunction with the frame;

FIGS. 11-13 illustrates an example of someone selecting a touch-selectable feature with the overlay with raised portions;

FIG. 14 illustrates an overlay for a single touch-selectable feature;

FIG. 15 illustrates a perspective view of a die-cut overlay;

FIG. 16 illustrates a perspective view of a die-cut overlay in conjunction with a frame;

FIG. 17 illustrates another view of an exemplary embodiment of a die-cut overlay with the frame.

### DETAILED DESCRIPTION OF EMBODIMENTS

Other embodiments and modifications of the present invention may occur to those skilled in the art subsequent to a review of the information presented herein; these embodiments and modifications, equivalents thereof, substantial equivalents thereof, or similar equivalents thereof are also included within the scope of this invention.

In the description below, various details have been omitted, such as the operation of touch screen displays, in order not to obscure the description of embodiments disclosed herein. “Screen” refers for example to the hardware having a graphical “display” thereon.

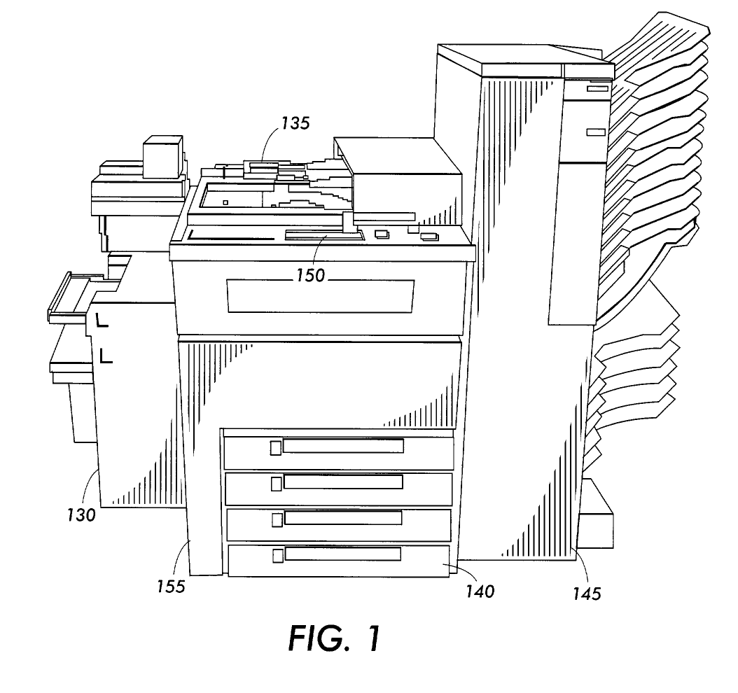

FIG. 1 illustrates an overall construction of an embodiment of a multi-function printing device having a touch screen control display. The printing device, as illustrated in FIG. 1, includes, for example, a scanning station 135, a printing station 155, and a finisher device 145, which can be a sorter, tower mailbox, stapler, etc. The printing station 155 can include a plurality of paper trays 140 that store the paper used in the printing process. Lastly, the printing device can include a high capacity feeder 130, which is capable of holding large amounts of paper stock to be used by the machine.

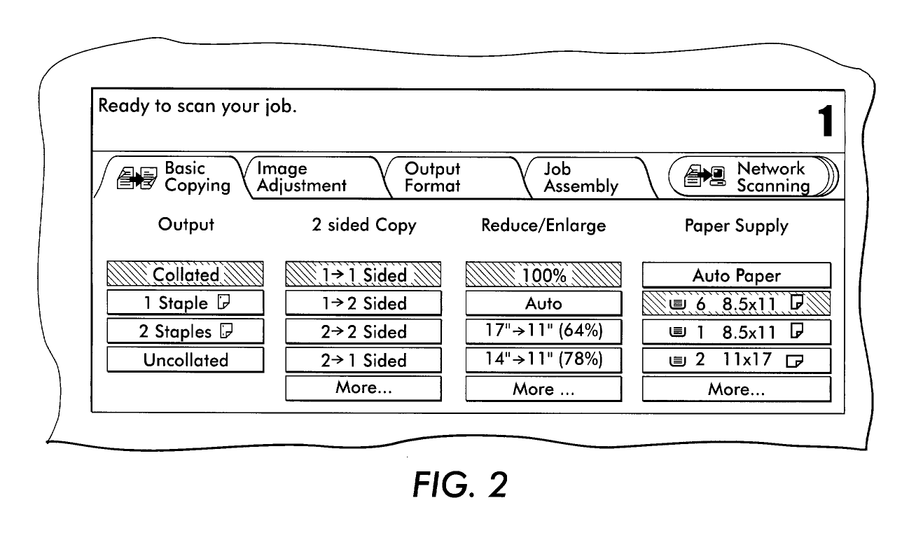

In addition, the printing device will often include a display screen 150 on which a GUI appears. The display screen 150 allows the user to control the various functions of the printing device by presenting various types of displays to the user which provides the user an opportunity to program certain job or function characteristics. In many devices, the display screen 150 is touch sensitive. It is generally difficult for visually impaired persons to use a touch sensitive screen without assistance. FIG. 2 illustrates an exemplary embodiment of a GUI that could appear on the screen 150.

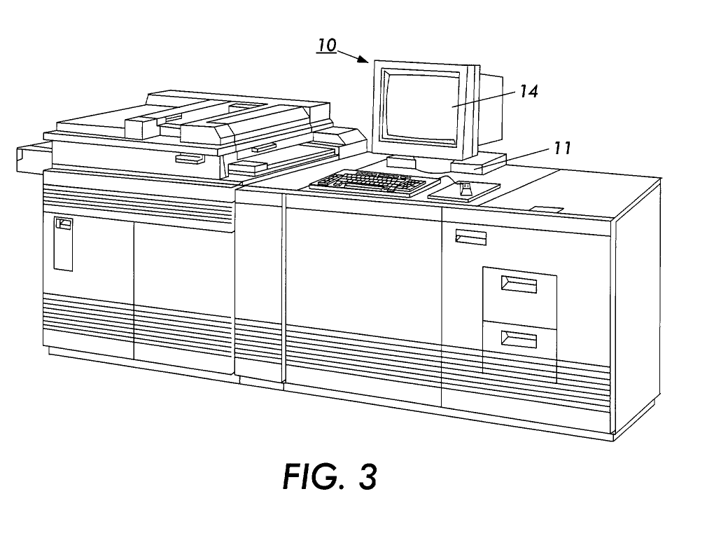

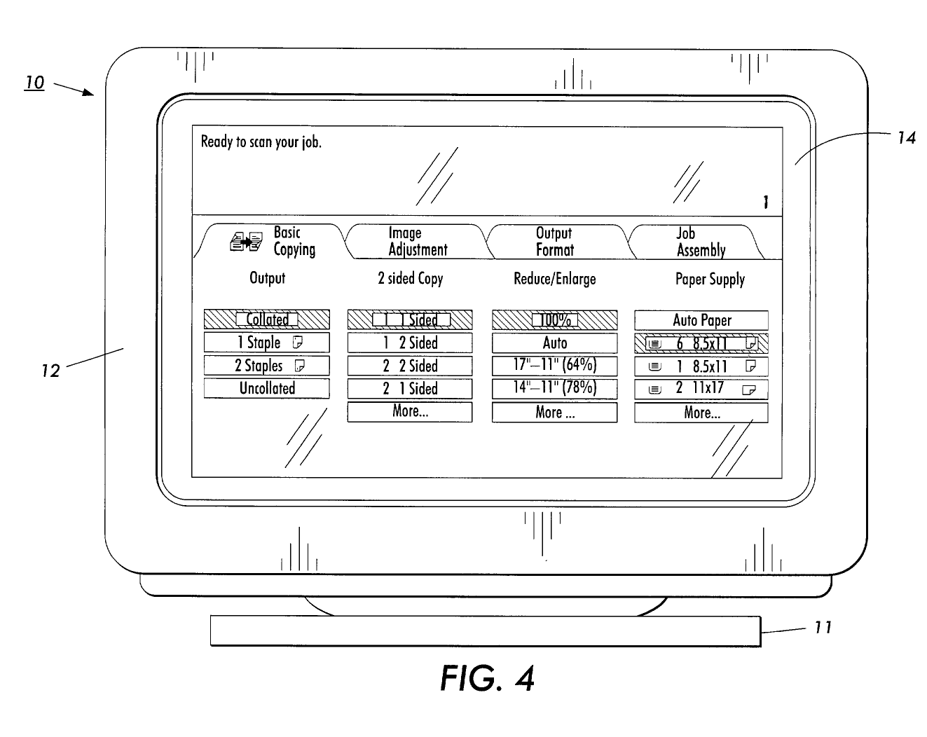

FIG. 3 illustrates an embodiment of a different printing device with a different display screen interface. In FIG. 4, the GUI appears on the monitor 10. In embodiments, the monitor is connected at its base 11 to the printing machine. A GUI appears on the display screen 14.

The embodiments disclosed herein can be used with any display screen having touch-sensitive features.

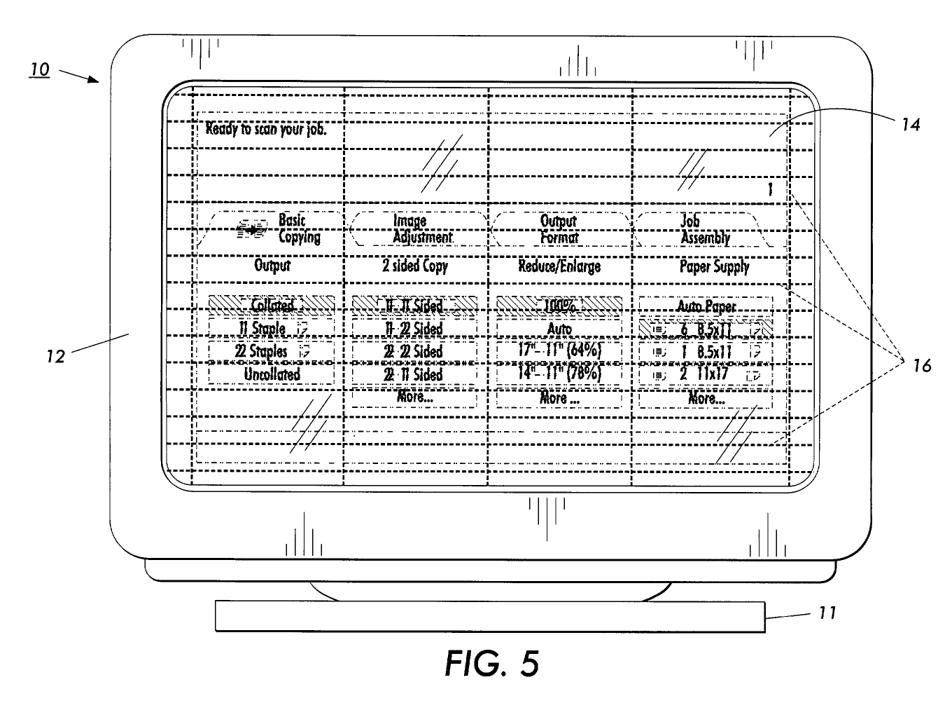

In most touch-screen displays, such as those illustrated in FIG. 5, the touch-sensitive features are arranged in a somewhat organized manner and corresponding to a substantially rectangular grid layout. The screen 14 itself is divided into a grid of potentially touch-sensitive areas 16. Most common prior art touch-sensitive screens work either (1) by the user interrupting a grid of infrared beams in front of the surface of the screen, or (2) by applying pressure to a membrane that causes a circuit to be completed. In the former, the potential touch-sensitive areas will always be arrayed in a grid format. In the latter, they typically are, but probably do not have to be. In any case, the center of each area 16 can be assigned coordinates. The graphics over top may have a variety of shapes and configurations, but the actual touch-sensitive areas of the screen have a particular area. If each touch-sensitive segment has an area A, then each feature displayed will have a selectable area A or integer multiple thereof covering an integer number of selectable areas.

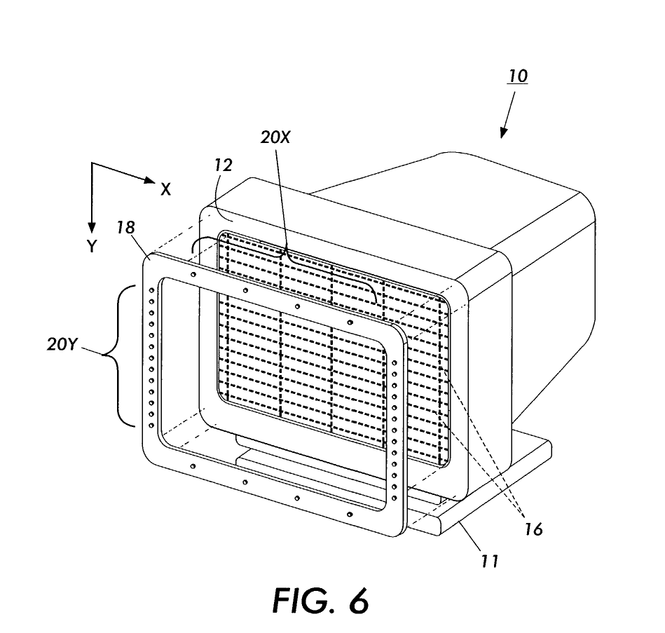

FIG. 6 illustrates an example of an embodiment of a frame 18 that can be used as a tactile aid to assist users with locating touch sensitive features on a display screen. A plurality of tactilely distinguishable areas 20 is located along each of at least two orthogonal sides or edges of the frame 18. These areas 20 are distinguishable from the remainder of the frame 18. In embodiments, these tactilely distinguishable areas 20 are simply raised areas of the frame 18. In other embodiments, they could simply have a different texture or include recesses or any other element that differentiates the texture of the distinguishable areas 20 from the remainder of the frame 18. In embodiments, the tactilely distinguishable areas 20 take the form of hemispherical or cylindrical protrusions. In embodiments, the protrusions 20 of the frame 18 can be located so that each intersection lies in the middle of a potential touch-sensitive area of the screen 14. Each of the plurality of protrusions 20X along the X-axis correspond to columns. Each of the plurality of protrusions 20Y along the Y-axis corresponds to a row. An (X,Y) coordinate exists to identify each potentially touch-selectable area 16 on the screen 14.

To use the frame to locate a touch-selectable feature, the user first attaches the frame 18 to the perimeter 12 of the display. In FIG. 6, the monitor screen 14 has a border area 12 that can be used. The user locates a first protrusion 20 located along a first side of the frame 18 and a second protrusion 20 located along a second side of the frame 18. The user would then move a finger or an implement such as, for example, a stylus, a pencil, a ruler, an eraser, or a stick in a line perpendicular to the side from which the user starts. The user's fingers and/or implements intersect at a touch-selectable feature where the user touches the screen 14 and selects the feature.

It is desirable to place the frame 18 as close to the edge of the display screen 14 as possible. Doing so lessens the distance a user's finger has to travel, and therefore the possibility and amount of error in locating a touch-selectable feature. In many cases people will not trace a perfect line that is perfectly orthogonal to the edge from which it starts, so the less distance traveled the less likely that any deviation will lead to a significant error.

It is imagined that even where touch-sensitive areas of a screen are arranged in a grid format, some displays will have different size grids than others. In other words, each touch-sensitive area of one screen will have an area A, while those of another will have A′, and other screens will have touch-sensitive areas of area A″, etc. Other frames having protrusions located at different intervals can be used for touch-screens with different grids.

In embodiments, a frame 18 could have fewer protrusions 20, where each protrusion would correspond to an X or Y coordinate of a touch-selectable feature on the display screen, i.e., superfluous protrusions 20 would be removed.

The protrusions 20 are raised sufficiently so that a user can easily distinguish by touch between the relatively flat surface of the frame 18 and the protrusions 20 of the frame 18. In embodiments, the adjacent sides of the frame 18 are substantially orthogonal to each other and opposing sides are substantially parallel to each other.

In embodiments, such as, for example, that illustrated in FIG. 6, the protrusions 20 are located on all four sides of the frame 20 with each touch-selectable feature located at the cross-section of four raised areas.

In embodiments, the screen has an uninterrupted periphery. However, the frame may have fewer than four complete sides. In the embodiment shown in FIG. 6, the protrusions 20 from the frame 18 are repeated along opposite sides. A user only needs raised areas along two sides of a frame in order to locate a point on the screen. Having points along all four sides helps a user more accurately pinpoint a location on a screen, but is not necessary for the frame to be useful. When raised areas are included only along two sides of the frame, there is a greater possibility that a user will travel off course in attempting to trace a line from a raised area on one side towards the other side. By having raised areas on all four sides of the frame, the furthest that a user would have to trace to reach a feature would be half the distance across the screen. This will lessen the possibility that a user's finger will stray off course. However, only protrusions along two substantially perpendicular sides are required. Therefore, in embodiments, L-shaped frames having only two sides can be used.

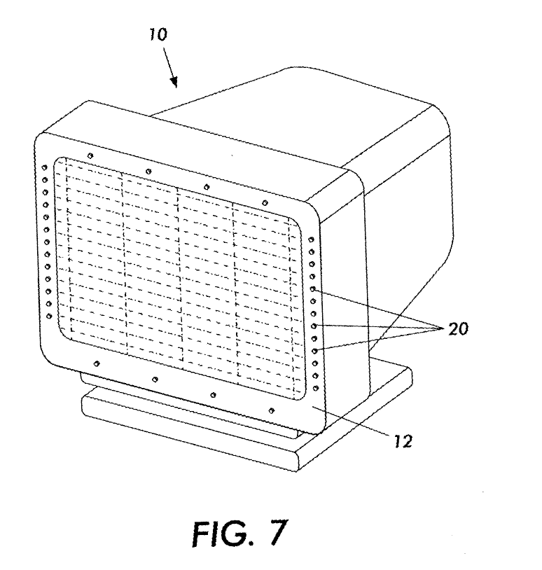

In embodiments, the frame may be removable. It could be held in place by any of a number of means including, but not limited to, adhesives, screws, velcro, or in cases of display screens that face upwards, gravity. In other embodiments, the frame 18 may be permanently attached to the periphery 12 of the viewing screen 14. In still other embodiments, such as, for example, the embodiment shown in FIG. 7, the tactilely distinguishable features 20 of the frame 18 may simply be molded into or otherwise integral with or made to be integral with the periphery 12 of the display screen 14.

In embodiments, the frame may also include tactilely readable markings, such as Braille markings, which, for example, could identify a row or column number so that the user did not have to count from one end to find a particular starting point.

In embodiments wherein the GUI includes only a couple of touch-sensitive areas, the frame 18 of FIG. 6 should be sufficient. A typical user could easily remember the relative locations of a few touch-sensitive areas. However, for GUI's with many active areas, the frame may not be enough on its own. It may have to be used in conjunction with other aids such as, for example, audio cues or more specific tactile information. Accidental selection of touch-sensitive areas could occur if a user used the frame by itself. One solution is for the user to use an implement that would not trigger the touch-sensitive feature. In some embodiments, a handheld wand, pointer, or other device having a sufficiently soft tip could be used, which would not trigger the feature. In other embodiments the frame can be used in conjunction with an audio feedback process, such as that disclosed in U.S. patent application Ser. No. 10/179,555, filed Jun. 24, 2002, (D/A2023) and incorporated herein by reference. In still other embodiments, the frame XX can be used in conjunction with an overlay such as that disclosed in U.S. patent application Ser. No. 10/113,105, filed Mar. 29, 2002 (D/A1632) and incorporated herein by reference.

In embodiments, an audible feedback ON/OFF switch is provided which turns an audible feedback feature on or off. In the OFF mode, the audible feedback feature otherwise disabled. In this mode, the software operates the touch screen's menu selections in the normal manner in which the machine is intended to perform. In other words, when a user selects a menu option from the machine's touch screen display the machine, activity associated with that option is immediately initiated whether it is a machine option such as selecting a different paper tray or a navigational option, such as jumping to another level of menu options. A second mode, for use in conjunction with the frame XX, is operates when the audible feedback feature has been turned ON or otherwise enabled. In this mode the software monitoring which row/column areas of the touch screen's display grid have been touched by the user in response to a menu option selection is toggled to initiate a two step process. In response to a user's first touch of an active grid menu option on the touch screen display, audible feedback is provided indicating to the user the nature of the particular menu option just selected. The activation of the machine activity associated with that menu option is not immediately initiated. A second consecutive touch of the same menu option by the user then activates that particular activity associated therewith.

In embodiments, the software associated with the touch screen display operates such that when the audible feedback feature is enabled, preferably by an ON/OFF switch associated therewith, an audible sound (such as an alt text attribute) is played for the user that preferably describes the element or option just touched. The user first starts at first and second raised areas along first and second adjacent sides of the frame 18. The user then locates a touch-sensitive area by moving a finger or pointing tool in a direction perpendicular to the first side of the frame 18 across the screen 14, starting at a first tactilely distinguishable area 20X. The user also moves another finger or pointing tool in a direction perpendicular to the second side of the frame 18 across the screen 18, starting at a second tactilely distinguishable area 20Y. The user then locates the intersection of these two lines. The user would hear the description of the menu selection just touched. Nothing in terms of machine activity would be initiated at this point. If the user decides upon hearing the description of the selection just touched that it is the correct one desired then upon a second touch of that same menu option, the monitoring software activates the appropriate machine activity or response associated with that chosen menu option. If the user decides that the selection just touched was not the one desired they user could then proceed to touch other options on the touch screen display and listen to the audible feedback for each of these menu selections. Once the user came across a selection the user desired they would press the desired selection again to activate the option.

For display screens with a significant number of touch-sensitive areas, the user will likely hear descriptions of other options as the user's finger or pointing tool moves across the screen. However, none of these will be activated unless the user selects them twice. The software can be further modified so that contact has to occur twice within a predetermined time period to help prevent accidental triggering of the selected touch-sensitive area.

In other embodiments, audible instructions can be used to notify the user which two protrusions will locate a particular selection. For example, an audio cue might inform a user that in order to select feature X, the user should start at the third raised area from the left in a horizontal direction and also start at the second raised are down in the vertical direction. The user would then trace a line from each raised area across the screen to locate the touch selectable feature.

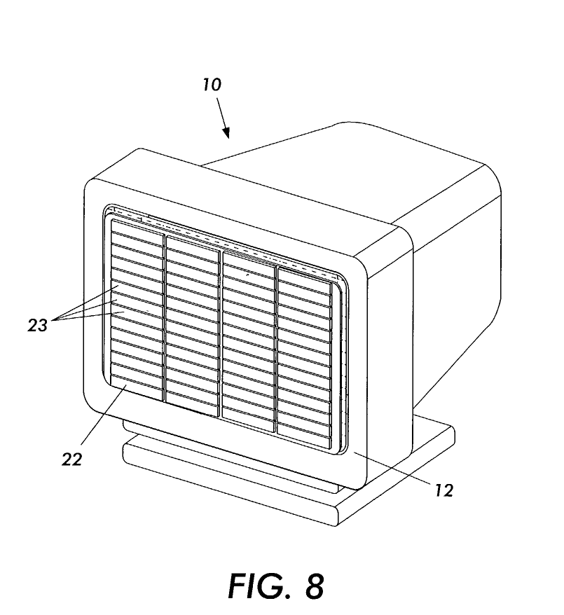

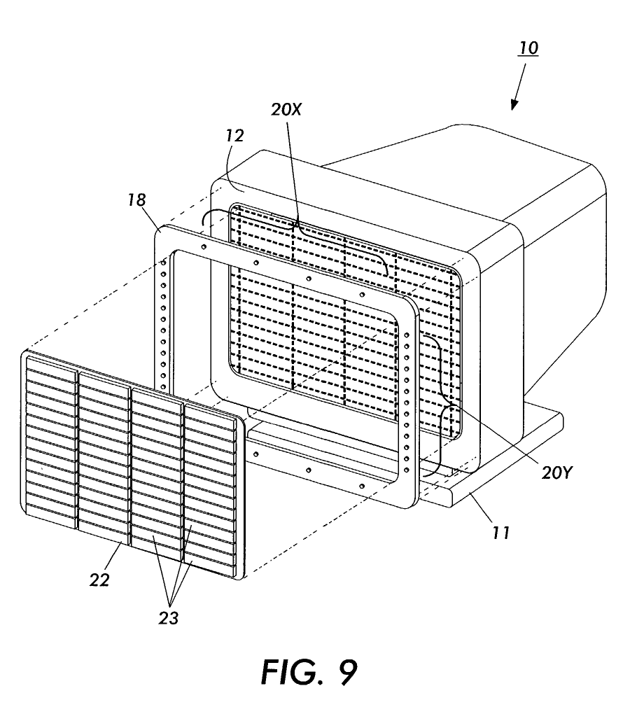

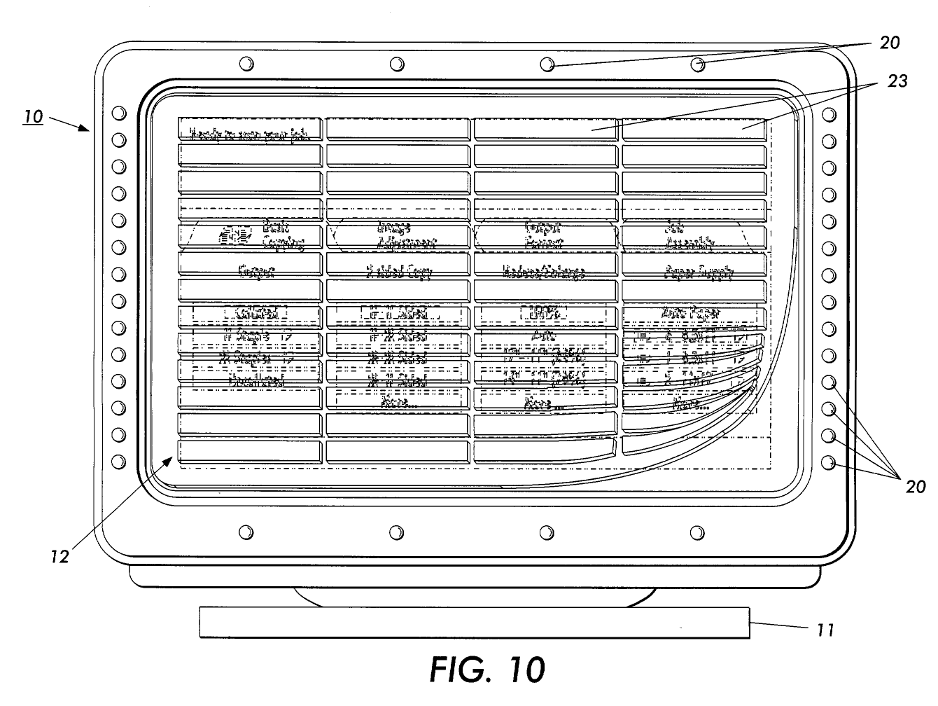

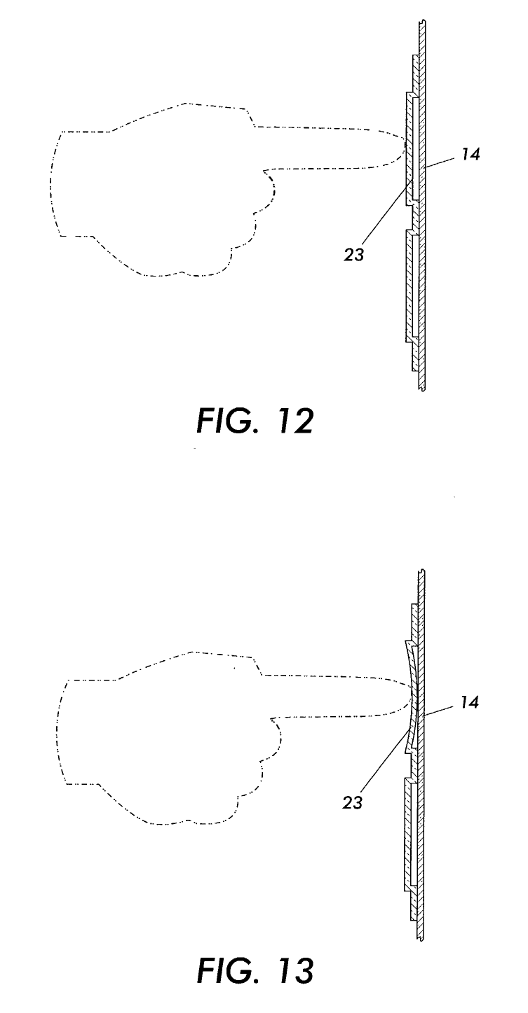

An alternative solution to accidental selecting touch-selectable features is illustrated in FIGS. 8-13. FIG. 8 illustrates an overlay 22 having raised portions 23 over the grid of touch-sensitive areas 16 of the screen. The raised portions 23 are designed to cover the touch-sensitive areas 16 of the screen. The raised portions 23 of the overlay 22 decrease the chance that a user will accidentally select a touch-selectable feature on the display. A user will have to actively press down on one of these raised areas 23 to select a feature. When a visually-impaired user is attempting to locate a touch-sensitive feature on the screen, the user will generally be applying relatively little pressure until the proper coordinates are located and therefore be much less likely to trigger a feature until that user decides to select it.

In embodiments, such as the one shown in FIGS. 8-11, the overlay has a standardized grid-like pattern of raised portions 23 corresponding to the grid of touch-sensitive areas on the screen. The size of each portion 23 will be approximately the same size or smaller than a touch-sensitive area on the screen. The size can actually be larger if the flexibility of the raised portion is such that a user pressing a raised portion 23 will apply pressure only within the perimeter of the touch-selectable area. In embodiments, the raised portions 23 of the overlay 22 have an area that is within 10% of an area of a touch-selectable feature over which the raised portion lies.

The height of the raised portions is dependent upon the flexibility of both the material used for the raised portions and the material used for the flat part of the overlay. The raised portions 23 must be flexible enough so that a user can deform a raised portion 23 sufficiently to contact the screen. The less flexible the raised portions 23 of the overlay 22 are, the closer they have to be to the surface of the screen 14. In embodiments, the raised portions 23 will be the same or similar material to the remainder of the overlay 22. However, the raised portions 23 may be made thinner or combined with other materials to make the raised portion flexible. In embodiments, a space of 1-2 mm beneath the raised portion 23 can be sufficient.

In embodiments for use with screens that do not have many active areas of the screen or where the touch-sensitive areas are not arrayed in a grid-like format, the overlay does not have to be arranged in a grid format. The raised portions 23 of the overlay 22 can be any shape or size necessary to match the size and shape of selectable features on the screen. If a particular screen has only two selectable features the overlay 22 may only have two raised portions 23.

The overlay 22 of FIG. 8 may be used by itself. In embodiments where the overlays are designed for specific screens, for example, the overlays may include readable tactile features, such as Braille features (not shown), which identify the selectable feature located beneath a raised portion 23.

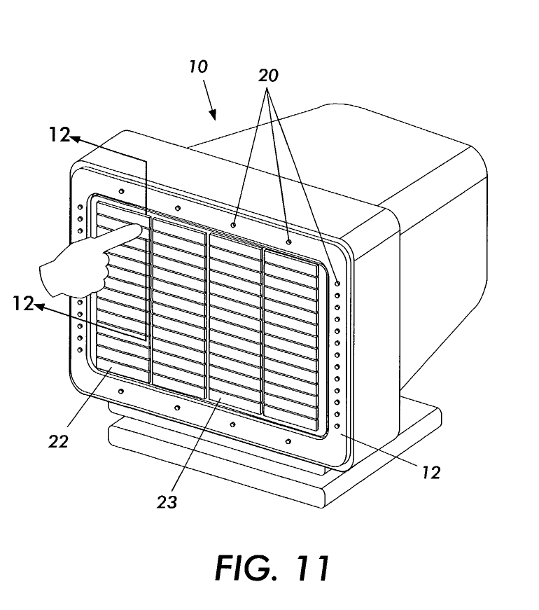

In other embodiments, the overlay 22 can be used in conjunction with the frame 18. FIGS. 11-13 illustrate the frame 18 used in conjunction with an overlay 22 having raised portions 23 over the grid of touch-sensitive areas 16 of the screen.

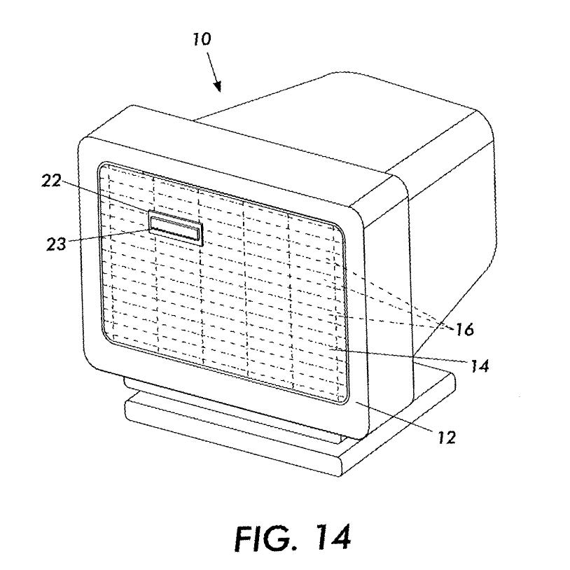

The overlay 22 does not have to cover the full screen. In embodiments, such as, for example, the embodiment shown in FIG. 14, individual mini-overlays can be used for screens that only have a few touch-sensitive areas. Each one could contain one raised portion 23, sized to cover a touch-selectable area. They could be removably placed over a display screen, reducing the chance of accidental selection of a touch-selectable feature.

Any number of methods may be used to hold the overlay to the screen. For example, the overlay can simply press fit to the screen. Many plastics are sufficient for press fitting. Embodiments have used 2 mil PVC or rubber. If a screen is sufficiently vertical, the overlay may still have difficulty staying in place. In cases where the overlay will not stay in place by press fit alone, other methods of securing the overlay in place may be used. These include, but are not limited to, clipping, use of a non-permanent adhesive, and taping. Tabs that extend beyond the edge of a screen may be used as well. Also, an adhesive material may be used to hold the overlay to a screen, such as, for example, the adhesive layer on the back of Post-It™ notes by 3M.

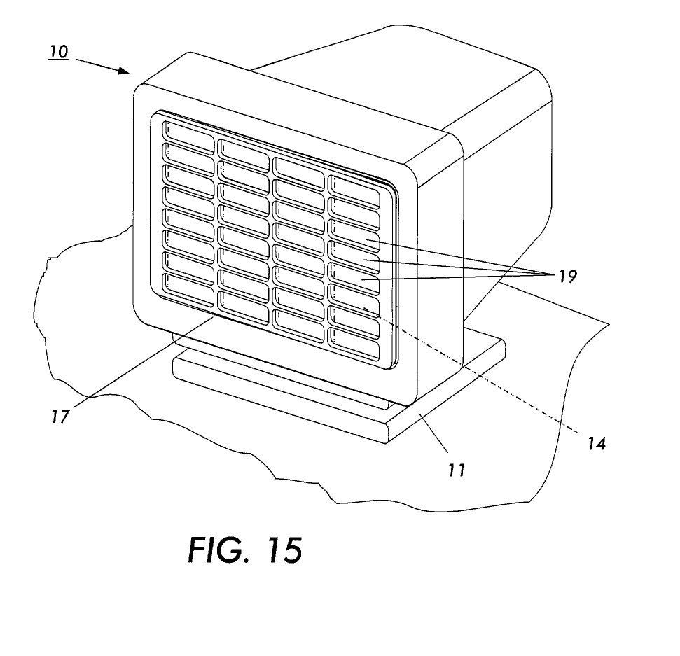

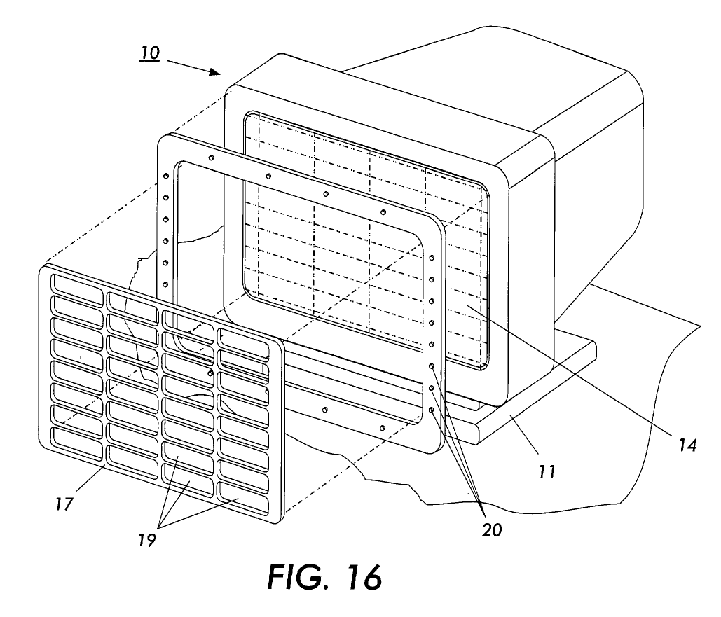

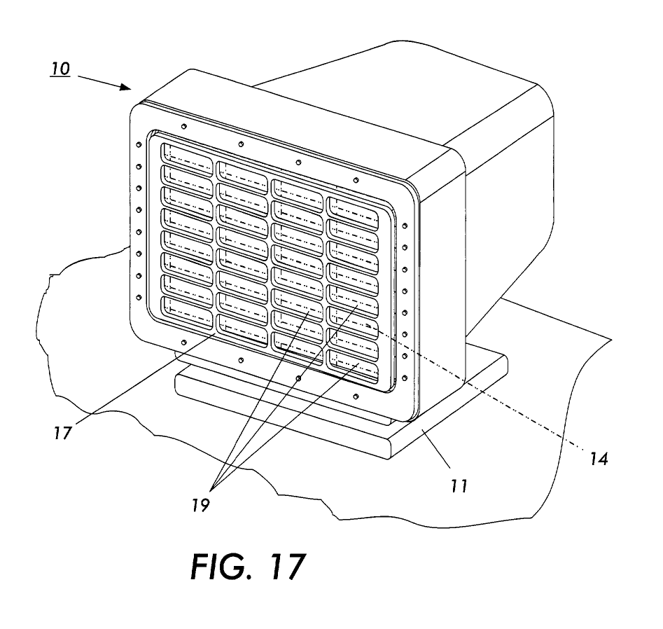

In embodiments, such as those illustrated in FIGS. 15-17, an overlay 17 having customized die cut holes 19 over the touch-selectable features on the screen can be used either with or without the frame 18. The die-cut holes 19 are approximately the same size as the touch-selectable areas beneath. The overlay 17 can be customized for a multitude of large monitor touch screens and for smaller user interfaces on the front panel of smaller printing devices, such as, for example, copiers/printers/faxes.

In embodiments, the overlay 17 is made from a thick film material, which creates a distinctive tactile edge that assists the user with alignment with the touch-selectable features on the touch screen. In embodiments, a thickness of at least 2 mm can be used. As with the raised portion overlay 22, the die-cut overlay 17 can be used in conjunction with the frame 18 or audible instructions. The audible instructions can lead the visually impaired user by stating the vertical and horizontal coordinates to a desired input function. In embodiments, the die-cut overlay 17 could contain tactilely readable areas such as, for example, Braille characters proximate to one or more of the holes or perhaps along the borders of the overlay. The grid pattern of the die-cuts can guide the user in selecting the proper settings on the touch screen without the use of add-on input devices.

In embodiments, the holes 19 in overlay 17 are arrayed in a grid layout. The holes 19 correspond to the grid of potentially touch-selectable areas 16 on the screen. However, in embodiments, each overlay 17 could have die-cut holes 19 only where a touch-selectable feature was located. The overlay can be laid out in a grid pattern as shown or it can correspond to the display on the screen and only have holes where features are located. Regardless, the overlay includes at least one hole located over a selectable feature located in the display on the screen 14.

The user first places the overlay 17 on the screen 14. The user locates the first selectable feature on the screen by touching the overlay and finding the hole. The user then selects the first selectable feature. If the user desires to select another feature on the screen, the user again locates the second hole on the screen. Tactilely readable areas on the overlay can be used to help a user determine which hole is which. Audio feedback, as described with respect to the frame 18 above, may also be used. The device may use audio feedback to inform the user what the selected touch-selectable feature is. The user could then select it again if it was the desired feature or select another if it was not.

The die-cut holes 19 can be produced with standard die cutting manufacturing processes. In embodiments, the film can include a low-tack adhesive for attaching to the surface of the actual touch screen surface, which would allow for easy removal so that newer overlays or other customized overlays could be used.

The overlays 17 and 22 can be made of any of a variety of materials or substrates including, but not limited to, plastics, fibrous material such as paper, nonwoven fabrics, thin metal foils, polyethylene, or thin layers of rubber materials such as neoprene. In embodiments, an overlay may cover the entire screen. In other embodiments, an overlay may only cover part of a screen or part of a display on the screen.

In embodiments, either the overlay having raised portions 22 or the die-cut overlay 17 can be substantially transparent (for example, from about 90% to about 100% light transmissive) or at least light transmissive enough so that an operator with full visual acuity can see through the overlay without interference. A fully sighted user may thus assist the visually impaired operator in efficiently learning to use this system.

However, the die-cut overlay 17 does not impede the use of the touch screen by other users without a visual impairment. Regardless of whether the die-cut overlay 17 is made transparent, a sighted user would be able to view the touch-selectable features through the holes. Therefore, the die-cut overlay 17 can be used by a sighted person even if the overlay is made opaque.

While the present invention has been described concerning specific embodiments thereof, it will be understood that it is not intended to limit the invention to these embodiments. It is intended to encompass alternatives, modifications, and equivalents, including substantial equivalents, similar equivalents, and the like as may be included within the spirit and scope of the invention as defined by the appended claims.

What is claimed:

1. An overlay for use with a screen, wherein the screen is a touch sensitive screen with a display containing at least one touch selectable feature thereon, the overlay comprising:
a substrate for placement over the screen, wherein the substrate includes at least one hole positioned over the at least one touch selectable feature.

2. The overlay of claim 1, wherein the overlay is light transmissive.

3. The overlay of claim 2, wherein the overlay is substantially transparent.

4. The overlay of claim 1, wherein the overlay is approximately 2 mm thick.

5. The overlay of claim 1, wherein the overlay further comprises at least one tactilely readable area.

6. The overlay of claim 5, wherein the tactilely readable area is proximate to the at least one hole

7. The overlay of claim 5, wherein the tactilely readable area includes raised protrusions.

8. The overlay of claim 7, wherein the raised protrusions are Braille characters.

9. The overlay of claim 1, wherein the overlay is substantially opaque.

10. The overlay of claim 1, wherein the hole is approximately the same size as the touch-selectable feature.

11. A method for using a device having a touch sensitive screen that has a display thereon, comprising:
placing a overlay on the screen, the overlay corresponding to the display on the screen and including a first hole corresponding to a first selectable feature located in the display on the screen;
locating the first selectable feature on the screen by touching the overlay and finding the first hole;
selecting the first selectable feature.

12. The method of claim 11, wherein the overlay includes a second hole corresponding to a second selectable feature located in the display on the screen, and further comprising:
locating the second selectable feature on the screen by touching the overlay and finding the second hole;
selecting the second selectable feature.

13. The method of claim 11, further comprising reading a tactilely readable area of the display in proximity with a hole to determine whether to select that hole.

14. The method of claim 11, further comprising:
listening for audible feedback regarding the touch-sensitive feature;
selecting the touch-sensitive feature again if the audible feedback describes a desired feature.

15. A system for assisting visually impaired persons with display screens having touch-selectable features, comprising:
an overlay including a plurality of holes arranged in a grid format,
wherein each bole overlies a potentially touch-selectable feature; and
a frame having at least two edges that are substantially orthogonal to each other, the frame configured to substantially coincide with a perimeter of a display screen;
a first plurality of tactilely distinguishable areas along a first edge of the frame;
a second plurality of tactilely distinguishable areas along a second edge of the frame substantially orthogonal to the first edge;
wherein the location of each of the plurality of touch-sensitive features can be represented by first and second coordinates on the screen, and
wherein the first coordinate corresponds to a position of one of the first plurality of tactilely distinguishable areas along the first edge and the second coordinate of the touch-sensitive feature corresponds to the position of one of the second plurality of tactilely distinguishable features along the second edge.

16. The overlay of claim 15, wherein the overlay is substantially transparent.

17. The aid of claim 15, wherein the frame is removably attached to the perimeter of the display screen.

18. The overlay of claim 15, wherein the overlay is substantially transparent.

19. The overlay of claim 15, wherein the overlay is approximately 2 mm thick.

20. The overlay of claim 15, wherein the overlay further comprises at least one tactilely readable area proximate to the at least one hole.
